(19) United States
(12) Patent Application Publication
(10) Pub. No.: US 2025/0256519 A1
(43) Pub. Date: Aug. 14, 2025

(54) Sealing member for transporting porous print media in a hybrid printer

(71) Applicant: CANON KABUSHIKI KAISHA, Tokyo (JP)

(72) Inventor: Marcus H.G.W. Hees, Echt (NL)

(21) Appl. No.: 19/050,957

(22) Filed: Feb. 11, 2025

(30) Foreign Application Priority Data
Feb. 12, 2024 (EP) 24157121.5

(51) Int. Cl. B41J 11/00; B41J 3/407; B41J 15/04; B41J 15/16

(52) U.S. Cl. CPC B41J 11/0085; B41J 3/4078; B41J 15/048; B41J 15/16

(57) ABSTRACT

A roll printer suited for transporting porous print media is provided. The printer includes a printing assembly configured to print an image on a print medium, a suction chamber arranged under the printing assembly during use and configured to suck the print medium, a transport belt having holes through which the print medium is sucked by the suction chamber and configured to transport the print medium while facing the printing assembly, and a sealing member configured for covering a portion of the porous print medium over the suction chamber and extending over at least a majority of a width of the print medium and/or the transport belt, so that the porous print medium is held onto the transport belt.

### CROSS-REFERENCE TO RELATED APPLICATIONS

This application claims the benefit of European Patent Application No. 24157121.5, filed Feb. 12, 2024, which is hereby incorporated by reference herein in its entirety.

### BACKGROUND OF THE DISCLOSURE

### Field of the Disclosure

The present disclosure relates to a roll printer, a sealing member for use in such a printer, and to a method for transporting a porous print medium on such a printer.

### Description of Background Art

US 2018/0281466 A1 discloses a roll printer comprising a porous, endless transport belt extending over a suction chamber and along a print assembly for printing an image on a porous print medium on the belt. A print medium may be provided in roll form on an input roller and extended over the belt toward a take-up roller. The print medium is sucked against the transport belt by means of a negative pressure applied in the suction chamber. Thereby, the print medium is held against the belt, so that print medium moves with the transport belt along the printing assembly. Certain print media are porous, such that they are permeable to air, for example by means of small openings or channels between the front side and the back side. When printing on porous print media, it was found that the print media are insufficiently sucked down against the transport belt. Since the porous print media are not reliably held onto the transport belt, their movement cannot be accurately controlled, which in turn makes it difficult to accurately print an image thereon. This is particularly disadvantageous on a scanning printer, which requires the different swaths for forming an image to be aligned with one another.

### SUMMARY OF THE DISCLOSURE

It is an aspect of the disclosure to increase the range for print media for a printer having an endless transport belt, specifically to increase the range to cover porous print media.

In accordance with the present disclosure, a printer, a sealing member, and a method are provided.

The printer includes a printing assembly configured to print an image on a print medium; a suction chamber arranged under the printing assembly during use and configured to suck the print medium; and a transport belt having holes through which the print medium is sucked by the suction chamber and configured to transport the print medium while facing the printing assembly; and a sealing member configured to cover a portion of the print medium over the suction chamber and extending over at least a majority of a width of the print medium and/or the transport belt, so that the print medium is held onto the transport belt.

It is the insight of the inventor that by reducing the leakage of air through the porous print medium over the suction chamber by means of a sealing member, the print medium becomes securely held between the transport belt and the sealing member, so that the print medium can be reliably transported by the transport belt. The sealing member is arranged to allow for the forward motion of the print medium on the belt, while the sealing maintains its seal on the print medium over the suction chamber. Before reaching the print assembly, the sealing member can be removed from the print medium to allow printing an image thereon. In this manner porous print media can be reliably transported by means of the suction transport belt, thus increasing the variety of print media which can be printed on a printer with such a transport belt. Thereby the aspect of the present disclosure has been achieved.

In an embodiment, the sealing member has a total width similar and/or comparable to that of the print medium and/or the transport belt. The sealing member extends in a width perpendicular to the transport direction of the transport belt over at least a major portion of the print medium and/or the transport belt. The sealing member when mounted over the belt has a width approximate to that of the print medium and/or the transport belt. The sealing member engages the print medium in its middle portion as well as at its side portions. Preferably, the sealing member covers in the width direction at least 50% of the print medium and/or the transport belt, very preferably at least 75% of the print medium and/or the transport belt, even more preferably at least 80% of the print medium and/or the transport belt, and extremely preferably at least 90% of the print medium and/or the transport belt.

It will be appreciated that to suck or sucking is herein preferably defined as applying a negative pressure to the suction chamber. The applied pressure is lower than the atmospheric pressure surrounding the printer. The negative pressure results in a normal force on the print medium, which forces the print medium against the transport belt. This results in increased frictional interaction between the print medium and the transport belt. In consequence, the print medium moves with the transport belt, when the belt moves in its transport direction.

It will further be appreciated that the holes in the transport belt are arranged to allow gas to pass through the transport belt. The holes are preferably through-holes. The holes may be any suitable openings in the transport belt, which form a passage between a first and a second, opposite side of the transport belt. The holes may be formed by perforating the transport belt and/or be integrally formed when forming the sheet material for the transport belt. In an embodiment, the transport belt comprises a woven mesh material, wherein the holes are formed by the spacings between fibers.

In an embodiment, the transport belt is an endless transport belt extending over the suction chamber and along the print assembly, so that the print assembly is able to print an image on the print medium when it is supported on the transport belt.

In an embodiment, wherein the print medium has a higher air permeability than the sealing member. Under the same pressure air passes much more difficultly through the sealing member than through the print medium. The resistance of the print medium with respect to the passage of air is less than that of the sealing member. The difference is at preferably at least 10%, very preferably at least 20%, even more preferably at least 50%.

In an embodiment, the printer comprises an input roller for holding a roll of porous print medium. The printer is preferably a printer with a roll-to-roll print mode or functionality. In a preferred embodiment, the printer is a hybrid printer, which in one of its print modes operates as a roll-printer comprising and using such an input roller. In another print mode, the printer may utilize a different input device for e.g. supplying individual rigid sheets. It will be appreciated that a roll printer herein is defined as a printer with at least one print mode, wherein the printer comprises an input roller for unwinding a print medium towards the transport belt.

In an embodiment, the sealing member is configured for preventing or reducing gas flow through the covered portion by at least half as compared to an uncovered state. It will be appreciated that the sealing need not be a perfect seal, but should substantially reduce air flow into the suction chamber. Preferably, the sealing member has an air permeability lower than that of the print medium and/or the transport belt, for example less than half, one-third, one-quarter, or one fifth of the air permeability of the print medium or the transport belt. The difference is air permeability is such that when the sealing member is applied to the print medium, the volume of air flow per unit per unit area per unit time is significantly reduced as compared to the transport belt, without and/or without the print medium on it.

In an embodiment, the sealing member comprises a substantially impermeable, flexible sheet. A flexible sheet easily conforms to the shape or geography of the print medium. This allows for easy application and removal of the sealing member to the print medium. In additional, damage or deformation of the print medium is avoided or reduced. A suitable impermeable sheet may also be formed of relatively low-costs materials, such as plastics like PVC, rubber, sheet metal, or any other suitable material.

In embodiment, the sealing member is arranged to be drawn against the print medium by means of a negative pressure applied to the suction chamber, thereby securing the portion of the print medium between the sealing member and the transport belt. The sealing member defines a hold-down region over the suction chamber. In the hold-down region, the sealing member is sufficiently near the transport belt, so that the negative pressure in the suction chambers draws the sealing member towards the transport belt. The sealing member has an active position in contact with the transport belt in absence of a print medium. It will be appreciated that the sealing member may further have a remote position away from the transport belt to allow for the printing of non-porous print media. In its active position the sealing member is arranged in a sealing state, while in the remote position the sealing member is prevented from entering its sealing state.

In an embodiment, sealing member is: movable into a sealing state wherein the sealing member covers a portion of the porous print medium over the suction chamber, preventing or reducing gas flow through the covered portion; movable with the print medium over the suction chamber in a transport direction defined by the transport belt while in the sealing state; and releasable from the portion of the print medium, so the portion is movable further into the transport direction uncovered.

In the sealing state, the sealing member covers and seals a portion of the porous print medium over the suction chamber. This results in said portion being securely held onto the transport belt. The sealing member is further configured to move with the print medium, as the transport belt moves. This allows the print medium to be transported, while the sealing members applies its seal. Before reaching a print area defined by the printheads, the sealing member is released from the print medium, so that it passes uncovered past the printheads. When active, the sealing member is in direct contact with the print medium, which print medium is in direct contact with the transport belt. When a print medium is loaded, the sealing member may be moved out of its sealing state to a remote position. In the remote position, the sealing member is away from the transport belt, so that the print medium can be loaded onto the transport belt. In a basic example, the sealing member is applied only after the print medium has been loaded. In another example, the sealing member may be in the sealing state during loading and the print medium is inserted between the sealing member and the transport belt. Adjustment means may be provided to adjust a spacing between the sealing member and the transport belt in accordance with a thickness of the print medium. Alternatively, the sealing member may be free to move in the vertical position, so that it presses onto the print medium by means of its weight and as a result of the negative pressure in the suction chamber.

In an embodiment, the sealing member defines: a contact position where the sealing member first contacts the print medium; a release position downstream of the contact position in the transport direction where the sealing member is released from the print medium; and a hold-down region extending between the contact position and the release position in the transport direction, in which hold-down region the sealing member is sucked towards the suction chamber.

In hold-down region the sheet of the sealing member is in its sealing state and is pulled towards the belt by the negative pressure in the suction chamber. During printing the hold-down region is preferably a horizontal area on the transport belt which overlaps the suction chamber. The contact and the release positions are preferably defined by a respective upstream and downstream sidewall of the suction chamber. The hold-down region is preferably at least as long as the suction chamber in the transport direction. It will be appreciated that additional suction chambers may be provided downstream of the suction chamber, which additional suction chambers are separated from the suction chamber by at least the downstream side wall. Preferably, in the hold-down region the sealing member moves in coupled motion with the transport belt. The sealing member holds the print medium in place on the transport belt, so that the transport belt, print medium, and sealing member move together at the same (average) speed. Preferably, the sealing member is sufficiently light and/or flexible, so that the printer can operate the transport belt at similar speeds, as when no sealing member is applied. The transport belt preferably moves in stepping transport at speeds of 10 s to hundreds of meters per second.

In an embodiment, the release position is upstream of a printing assembly comprising at least one inkjet printhead. The printer is an inkjet printer wherein its printing assembly defines a print area on or over the belt. The sheet of the sealing member is removed from the print medium before the print medium moves into the print area.

In an embodiment, the contact position is downstream of and adjacent to an upstream support roller for supporting the transport belt. The upstream side of the suction chamber is preferably near the upstream support roller to realize a compact design and facilitate easy loading of print media. This upstream roller is preferably provided with a drive for rotating said support roller.

In an embodiment, the sealing member comprises an endless sealing belt. The flexible sheet is formed into an endless belt, which cyclically runs over a pair of rollers. This allows the sealing member to substantially remain in position while providing sealing over the moving print medium. Preferably, the sealing belt is arranged to run freely and is not provided with a dedicated drive. The sealing belt in the sealing state is moved by driving the transport belt.

In an embodiment, the roll printer further comprises an assembly of sealing members positioned besides one another in a width direction of the transport belt perpendicular to the transport direction, wherein each sealing member is independently rotatable or pivotable with respect to the others around a respective axis extending in a height direction perpendicular to a print medium support plane defined by the transport belt. Multiple sealing members are provided in an array extending in the lateral direction of the transport belt, preferably spanning substantially the full width of the belt. To prevent or reduce wrinkling of the print medium due to local variations in transport velocities within the print medium, each sealing member is freely rotatable around a during use vertical axis. This allows each sealing member to be directed parallel to the local direction of motion of the print medium.

In an embodiment, the assembly of sealing members is removably mounted on the printer, so that each sealing member can be moved to a remote position wherein during printing contact between the sealing members and the print medium is prevented. Each sealing member has an active position, wherein it is in contact with the print medium on the transport belt. This active position is near or at the transport belt. In a remote or inactive position a sealing member has been moved away from the transport, so that it does not affect the transport of print media by the transport belt.

In an embodiment, the printer further comprises a fluid collection channel mountable opposite a printing assembly for collecting marking material passing through the print medium during printing. The porous print medium is uncovered when facing the printing assembly. Due to the porosity a portion of the marking material printed on the print medium may pass through the print medium. To prevent this marking material from contaminating the printer or the print medium, the fluid collection channel is inserted opposite the printing assembly. The fluid collection channel is below the printing assembly and below the print medium in the direction of gravity to collect marking material flowing through the print medium. Preferably, the fluid collection channel is positioned above the transport belt to prevent the marking material from reaching the transport belt. Therein, the print medium is redirected to adjust to the path defined by the fluid collection channel. Alternatively, the fluid collection channel may be insertable below the transport belt to collect the marking material there.

The present disclosure further relates to a sealing member for use in the above described, wherein the sealing member further includes mounting elements for mounting the sealing member in the printer. The sealing member may be provided to an existing printer by means of the mounting elements, which provide a suitable secure and rigid connection to the printer. The mounting elements are preferably fasteners, such as screws, bolts, clamps, etc.

The present disclosure further relates to a method for transporting a porous print medium in a printer having an endless transport belt with holes therein, the method includes the steps of: applying a negative pressure to a first side of the print medium in a hold-down region; covering a portion of the print medium in the hold-down region with a sealing member extending over at least a majority of a width of the print medium, so that the sealing member is sucked onto the print medium; driving the transport belt, thereby moving the print medium that is being held between the transport belt and the sealing member by the negative pressure.

In the hold-down region a negative pressure is applied to the side of the print medium facing the transport belt. While the print medium is porous due to the holes, it is covered by the sealing member, which prevents or substantially reduces the air flow through the print medium in the hold-down region. In consequence, the sealing member and the print medium are sucked against the transport belt and held in place there by the negative pressure. When the transport belt is then driven, this holding ensures that the print medium is accurately moved with the transport belt. Thus, a porous print medium can be accurately transported using a suction transport belt, allowing it to be printed on.

In an embodiment, the method further includes the steps of: releasing the sealing member from the print medium; and printing an image on the released print medium.

The sealing member in combination with the negative pressure provides a sufficient frictional holding force between the print medium and the transport belt, so that the print medium is moved towards the printing assembly. Before printing on a portion of the print medium, the sealing member is removed, so that the side of the print medium opposite the transport belt is free for printing thereon.

In an embodiment, the sealing member has a gas permeability smaller than that of the print medium and/or the transport belt. The sealing member, which is preferably formed of a sheet, which has been formed to be much less permeable to air than the print medium and/or the transport belt. Preferably, the sealing member's sheet is formed of a closed, sealed, or impermeable material. It will be understood that a limited degree of gas permeability is acceptable for the sealing member. The sealing member is sufficiently impermeable to allow sufficient negative pressure to be achieved in the suction chamber in a relatively short time and maintained during printing.

In an embodiment, the sealing member is formed of an impermeable, flexible sheet, which cyclically passes over the hold-down region. The sheet runs along an endless loop over the transport belt.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure, and wherein:

FIG. 1 is a schematic perspective view of a printing system according to the present disclosure in a first printing mode;

FIG. 2 is a schematic perspective view of a printing system in FIG. 1 in the second printing mode;

FIG. 3 is a schematic side view of the input side of the printing system in FIG. 2 in a third printing mode;

FIG. 4 is a schematic top-down view of the input side of the printing system in FIG. 2 in the third printing mode; and

FIG. 5 is a schematic side view of the input side and a print area of the printing system in FIG. 2 in the third printing mode.

### DETAILED DESCRIPTION OF THE EMBODIMENTS

The present disclosure will now be described with reference to the accompanying drawings, wherein the same reference numerals have been used to identify the same or similar elements throughout the several views.

### Printing System

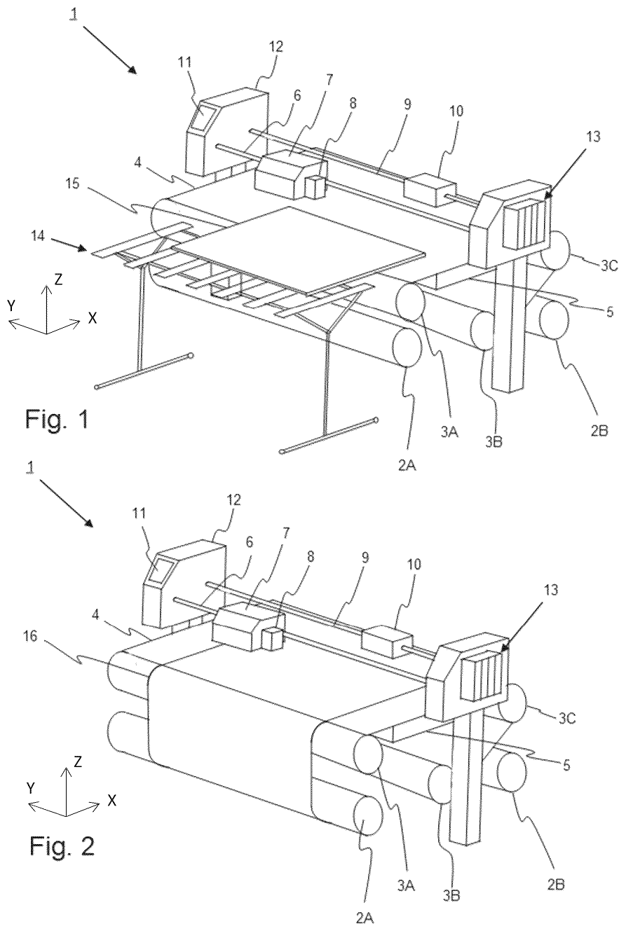

FIG. 1 shows a wide format inkjet printer 1. The wide-format printer 1 includes an inkjet printing assembly 7 for printing on a print medium 15. The print medium 15 in FIG. 1 is a relatively rigid substrate, such as a panel. The print medium 15 is supplied from a media input unit 14, which can be configured for storing a plurality of such print media 15 and supplying these to the printer 1. The printer 1 includes transport means for receiving and transporting the print medium 15 along the inkjet printing assembly 7. In FIG. 1, the transport means includes an endless transport belt 4 supported on a plurality of support rollers 3A, 3B, 3C. At least one of the support rollers 3A, 3B, 3C is provided with driving means for moving the belt 4. Additionally, one or more one of the support rollers 3A, 3B, 3C can be configured to be moved and/or tilted to adjust and control the lateral position of the belt 4. The inkjet printing assembly 7 may be provided with a sensor 8, such as a CCD camera, to determine the relative position of belt 4 and/or the print medium 15. Data from said sensor 8 can be applied to control the position of the belt 4 and/or the print medium 15. The belt 4 is further provided with through-holes and a suction chamber 5 in connection with a suction source (not shown), such that an underpressure can be applied to the print medium 15 via the through-holes in the belt 4. The underpressure adheres the print medium 15 flatly to the belt 4 and prevents displacement of the print medium 15 with respect to the belt 4. Due to this holding, the belt 4 is able to transport the print medium 15. It will be appreciated that other suitable transport means, such as rollers, steppers, etc, may alternatively be applied. The print medium 15 can be transported stepwise and/or in continuous movement.

The inkjet printing assembly 7 is configured to translate along a first guide beam 6 in a scanning direction. The scanning direction is perpendicular to the direction in which the print medium is transported by the belt 4. The inkjet printing assembly 7 holds a plurality of print heads (not shown), which are configured to jet a plurality of different marking materials (different colors of ink, primers, coatings, etc.) on the print medium 15. Each marking material for use in the printing assembly 7 is stored in one of a plurality of containers arranged in fluid connection with the respective print heads for supplying marking material to said print heads to print an image on the print medium 15.

The ejection of the marking material from the print heads is performed in accordance with data provided in the respective print job. The timing by which the droplets of marking material are released from the print heads determines their position on the print medium 15. The timing can be adjusted based on the position of the inkjet printing assembly 7 along the first guide beam 6. The above-mentioned sensor 8 can therein be applied to determine the relative position and/or velocity of the inkjet printing assembly 7 with respect to the print medium 15. Based upon data from the sensor 8, the release timing of the marking material can be adjusted.

Upon ejection of the marking material, some marking material may be spilled and stay on a nozzle surface of the print heads. The marking material present on the nozzle surface, can negatively influence the ejection of droplets and the placement of these droplets on the print medium 15. Therefore, it can be advantageous to remove excess marking material from the nozzle surface. The excess marking material may be removed for example by wiping with a wiper and/or by application of a suitable anti-wetting property of the surface, e.g. provided by a coating.

The marking materials may require treatment to properly fixate them on the print medium. Thereto, a fixation unit 10 is provided downstream of the inkjet printing assembly 7. The fixation unit 10 can emit heat and/or radiation to facilitate the marking material fixation process. In the example of FIG. 1, the fixation unit 10 is a radiation emitter, which emits light of certain frequencies that interacts with the marking materials, for example UV light in case of UV-curable inks. The fixation unit 10 in FIG. 1 is translatable along a second guide beam 9. Other fixation units 10, such as page-wide curing or drying stations may also be applied. Further, the inkjet printing assembly 7 can be provided with a further fixation unit on the same carriage that holds the print heads. This further fixation unit can be used to (partially) cure and/or harden the marking materials, independent of or interaction with the fixation unit 10.

After printing, and optionally fixation, the print medium 15 is transported to a receiving unit (not shown). The receiving unit can include a take-up roller for winding up the print medium 15, a receiving tray for supporting sheets of print medium 15, or a rigid media handler, similar to the media input unit 14. Optionally, the receiving unit can include processing means for processing the medium 15 after printing, e.g. a post-treatment device such as a coater, a folder, a cutter, or a puncher.

The wide-format printer 1 furthermore includes a user interface 11 for receiving print jobs and optionally for manipulating print jobs. The local user interface unit 11 is integrated to the print engine and can include a display unit and a control panel. Alternatively, the control panel can be integrated in the display unit, for example in the form of a touch-screen control panel. The local user interface unit 11 is connected to a control unit 12 connected to the printer 1. The control unit 12, for example a computer, includes a processor adapted to issue commands to the printer 1, for example for controlling the print process. The printer 1 can optionally be connected to a network. The connection to the network can be via cable or wireless. The printer 1 can receive printing jobs via the network. Further, optionally, the control unit 12 of the printer 1 can be provided with an input port, such as a USB port, so printing jobs can be sent to the printer 1 via this input port.

### Hybrid Printing System

The printer 1 in FIG. 1 is a so-called hybrid printer, capable of handling both flexible media and rigid substrates. In FIG. 1, the printer 1 operates in a first print mode, wherein the printer 1 is configured for transporting rigid substrates, such as the print medium 15. Such rigid print media 15 can be panels for doors, walls, etc, corrugated media, plates formed of plastic or metal, etc. To handle these rigid print media 15, the printer 1 in FIG. 1 is configured with a substantially linear transport path: from the media input device 14, the print medium 15 moves forward along the inkjet printing assembly 7 at a at substantially constant height. The media input unit 14 and the receiving unit are positioned at the level of the medium support surface of the belt 4. In FIG. 2, a flexible web medium 16 is supplied to the printer 1, which web medium 16 can be composed of e.g. paper, label stock, coated paper, plastic or textile. The web medium 16 is supplied from the input roller 2A and extends across the belt 4 to the take-up roller 2B, where the web medium 16 is re-wound. The printer 1 is configured to swiftly and efficiently switch between print modes.

### Transporting Porous Media

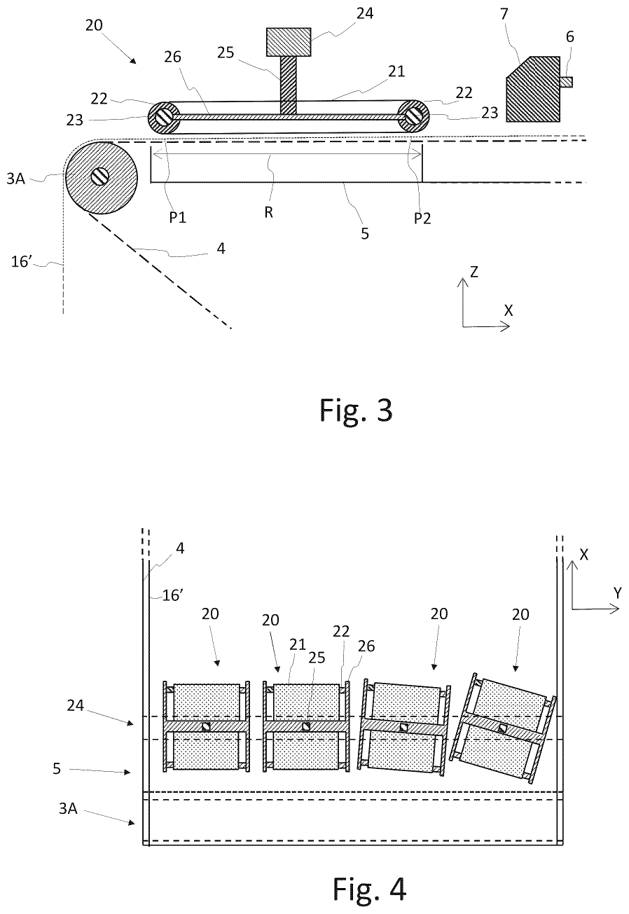

In FIG. 3, the printer 1 is configured to operate in a third print mode for printing on porous print media 16′, which is a specialized mode for printing roll media that have a high level of porosity. The third print mode utilizes the rollers 2A, 2B and the transport belt 4 similarly to FIG. 2 with additional components to reliably transport the porous print medium 16′.

FIG. 3 illustrates the upstream side of the transport belt 4 near the upstream support roller 3A. In FIG. 3, a porous print medium 16′ in the form of a web is spooled from the input roller 2A over the transport belt 4 towards the take-up roller 2B. The print medium 16′ is porous, so that it has a relatively high air permeability. Such print media are for example textiles, hole sheets, mesh materials, etc. Gas, specifically air, passes relatively easy through such print media, for example due to the presence of through-holes or channels that run between the opposite sides of the print media. Porous print media are generally difficult or impossible to transport on the printer 1 as in FIG. 2, since air passes through the print medium 16′. The pressure difference between the opposite sides of the print medium 16′ is then relatively small, so that the porous print medium 16′ is not sufficiently pulled against the transport belt 4. This can result in the transport belt 4 slipping past the print medium 16′ instead of moving it forwards in the transport direction X due to insufficient friction between the two.

Reliable transport of porous print media 16′ can be achieved by providing a sealing member 20, as shown in FIG. 3, over the transport belt 4 in the region where the negative pressure is applied. The sealing member 20 includes a flexible, impermeable sheet in the form of an endless sealing belt 21. The sealing belt 21 is supported on two rollers 22. The rollers 22 are mounted freely rotatable on their respective rotation axes 23. This allows the sealing belt 21 to move with the transport belt 4, when there is sufficient friction between the sealing belt 21 and the print medium 16′ on one hand and the print medium 16′ and the transport belt 4 on the other hand.

The rotation axes 23 are in turn mounted onto a frame 26, which connects them to a rotational bearing 25. The rotational bearing 25 mounts the sealing belt 21 rotatably onto a support beam 24, which is rigidly connected to a frame of the printer 1 or the floor. The rotational bearing 25 allows the belt 21, frame 26, and rollers 22 to freely rotate around an axis in the vertical direction Z.

As shown in FIG. 4, an assembly of multiple sealing members 20 are provided in a row in the lateral direction Y. Each sealing member 20 is mounted rotatably on the support beam 24 independent from the others. Each rotational bearing 25 can include limiters or restrictors to restrict the rotation within a predetermined range to prevent contact between the sealing different 20. The sealing members 20 together extend over the substantially full width of the transport belt 4 in the lateral direction Y. Space is available between sealing members 20 and at the edges of the transport belt 4 to allow room for the respective rotations. The sealing members 20 are positioned over the suction chamber 5.

The sealing member 20 allows a porous print medium to be transported by means of the transport belt 4. Porous is herein defined as the print medium having a high gas or air permeability as compared to the lower permeability of sealing member, preferably at least two (2) times greater, more preferably at least five (5) times, and even more at least 10 times greater. When uncovered, the porous print medium 16′ is so permeable to air that a relatively large flow of air passes through the print medium 16′ into the suction chamber 5 due to the suction source drawing in air from the suction chamber 5. As a consequence of this high air permeability, the pressure difference between opposite sides of the print medium 16′ is small, so that the normal force on the print medium 16′ is small. The friction between the transport belt 4 and the print medium 16′ may then be too small to ensure a reliable holding of the print medium 16′ on the transport belt 4. As a consequence, the transport belt 4 may be unable to controllably transport the print medium 16′, so that an image cannot be accurately printed on it. To prevent this, the assembly of sealing members 20 is mounted on the printer 1, as shown in FIGS. 3 and 4.

The sealing belt 21 of the belt sealing member 20 is formed of a flexible sheet with an air permeability significantly lower than that of the print medium 16′. The sheet covers the print medium in the hold-down region R between the contact position P1 and the release position P2. The sheet covers and substantially seals the print medium 16′ in the hold-down region R. Due to the lower air permeability, the flow of air leaking into the suction chamber 5 is relatively small, so that the negative pressure in the suction chamber 5 is able to build up to a level at which the sheet is sucked towards the transport belt 4. This downward force on the sheet presses the print medium 16′ against the transport belt 4. The negative pressure is sufficient so that the print medium 16′ becomes frictionally secured between the transport belt 4 and the sheet of the sealing member 20. The friction on both sides of the print medium 16′ is sufficiently large, so that when the transport belt 4 is driven, the print medium 16′ and the sheet of the sealing member 20 move synchronously with the transport belt 4.

When driving the transport belt 4, the sheet of the sealing member 20 moves with the print medium 16′ and the transport belt 4 through the hold-down region R. In FIG. 3, this is achieved by forming the sheet as an endless sealing belt 21, which moves along a unidirectional or cyclic path between the contact position P1 and the release position P2. At the contact position P1, the sealing belt 21 first contacts the print medium 16′ and begins covering it, thereby sealing the print medium 16′ moving into the hold-down region R. In the hold-down region R, the print medium 16′ is securely held between the transport belt 4 and the sealing belt 21. Movement of the transport belt 4 is thus transferred to the sealing belt 21, which revolves freely around its rollers 22. At the release position P2, the sealing belt 21 is released from the print medium 16′ by directing it upwards in the vertical direction Z. The release point P2 preferably corresponds with a downstream side wall which delimits the suction chamber 5. Viewed in the vertical direction Z, the length of the sealing belt 21 is preferably at least equal to and/or overlapping the suction chamber 5. Downstream of the suction chamber 5, additional suction chambers can be provided, e.g. for use in other print modes.

The print medium 16′ can be relatively wide, e.g. over 3 meters, and is generally formed of a flexible material. The local direction of movement of the print medium 16′ can vary across the lateral direction Y. To prevent wrinkling the print medium 16′, the different sealing belts 21 are able to rotate freely around an axis in the vertical direction Z to follow the local movement of the print medium 16′. This reduces the chance of wrinkling in the print medium 16′. Limiters are provided in the rotational bearings 25 of each sealing member 20, so that these are rotatable only within a restricted range to avoid collisions between sealing members 20. Optionally, urging member can be provided to return the sealing members 20 to a starting orientation or angle in absence of an external force.

The assembly of sealing members 20 is applied for porous print media 16′. When non-porous print media 15, 16 are applied, such as e.g. in FIG. 1, the sealing members 20 are moved to a remote location away from the transport belt 4, so that the non-porous print media 15, 16 can be handled by the printer 1 without interference of the sealing members 20. In one embodiment, the support beam 24 is provided with a lift for raising the sealing members 20 above the transport belt 4. This lift may also be utilized when loading a new porous print medium 16′. In another embodiment, the assembly of sealing members 20 is easily mountable or de-mountable from the printer 1, for example by providing the support beam 24 with wheels and a lock to fix it in place with respect to the transport belt 4.

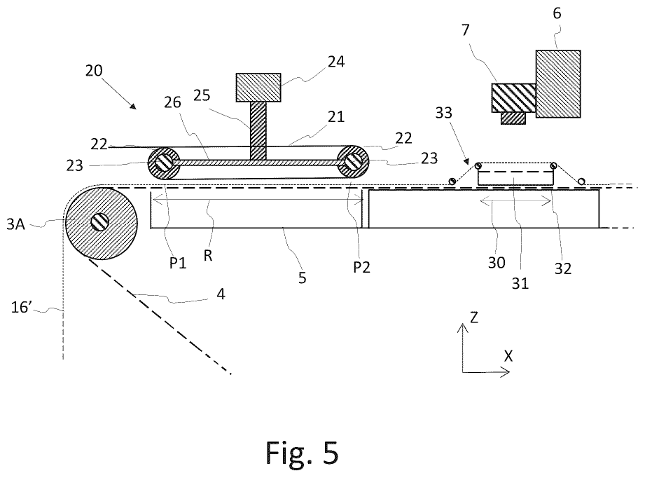

FIG. 5 illustrates a fluid collection channel 31 in the form of a tray positioned opposite the printing assembly 7 in a print area 30. The inkjet printing assembly 7 jets marking material towards the porous print medium 16′. Due its porosity, some marking material may seep or flow through the porous print medium 16′. This marking material may contaminate certain components of the printer, such as the transport belt 4 or the back side of the print medium 16′. Since this marking material flows below the print medium 16′, it is difficult to harden, for example by curing lamps, so that it remains fluid for a relatively long period of time. The fluid collection channel 31 prevents this contamination by being positioned directly below the print medium 16′ opposite the printing assembly 7 to catch any marking material passing through the print medium 16′. Below the transport belt 4, a support structure 32 can be provided to ensure that the transport belt 4 remains level and/or straight under the weight of the fluid collection channel 31 and its contents. A bypass path 33 is formed by bypass rollers to direct the print medium 16′ over the fluid collection channel 31. The fluid collection channel 31 and the components of the bypass path 33 are preferably easily mountable and removable to allow the printer 1 to switch between print modes. In the print area 30, the transport of the print medium 16′ is preferably controlled by driving the take-up roller 2B, so that the print medium 16′ is tensioned and pulled tight in the print area 30. In another embodiment, the fluid collection channel 31 may be provided below the transport belt 4, either as removable or permanent tray. The fluid collection channel 31 may further be provided with a drain for easily removing fluid from its tray.

Although specific embodiments of the disclosure are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A printer comprising:
a printing assembly configured to print an image on a print medium;
a suction chamber arranged under the printing assembly during use and configured to suck the print medium;
a transport belt having holes through which the print medium is sucked by the suction chamber and configured to transport the print medium while facing the printing assembly; and
a sealing member configured to cover a portion of the print medium over the suction chamber and extending over at least a majority of a width of the print medium and/or the transport belt, so that the print medium is held onto the transport belt.

2. The printer according to claim 1, wherein the sealing member has a lower air permeability than the print medium.

3. The printer according to claim 1, wherein the sealing member is arranged to be drawn against the print medium by means of a negative pressure applied to the suction chamber, thereby securing the portion of the print medium between the sealing member and the transport belt.

4. The printer according to claim 1, wherein sealing member is configured to be:
movable into a sealing state in which the sealing member covers a portion of the porous print medium over the suction chamber, preventing or reducing gas flow through the portion of the porous print medium covered by the sealing member;
movable with the print medium over the suction chamber in a transport direction defined by the transport belt while in the sealing state; and
releasable from the portion of the print medium, so the portion is movable further into the transport direction uncovered.

5. The printer according to claim 4, wherein the sealing member defines:
a contact position where the sealing member first contacts the print medium;
a release position downstream of the contact position in the transport direction where the sealing member is released from the print medium; and
a hold-down region extending between the contact position and the release position in the transport direction, the hold-down region being where the sealing member is sucked towards the suction chamber.

6. The printer according to claim 5, wherein the release position is upstream of the printing assembly having at least one inkjet printhead, and wherein the contact position is downstream of and adjacent to an upstream support roller configured to support the transport belt.

7. The printer according to claim 4, wherein the sealing member comprises an endless sealing belt.

8. The printer according to claim 7, further comprising an assembly of sealing members positioned besides one another in a width direction of the transport belt, the width direction being perpendicular to the transport direction, wherein each sealing member is independently rotatable or pivotable with respect to the other sealing members around a respective axis extending in a height direction perpendicular to a print medium support plane defined by the transport belt.

9. The printer according to claim 8, wherein the assembly of sealing members is removably mounted on the printer, so that each sealing member can be moved to a remote position where, during printing, contact between the sealing members and the print medium is prevented.

10. The printer according to claim 1, further comprising a fluid collection channel mounted opposite the printing assembly and configured to collect marking material passing through the print medium during printing.

11. A method for transporting a porous print medium in a printer having an endless transport belt with holes therein, the method comprising:
applying a negative pressure to a first side of the print medium in a hold-down region;
covering a portion of the print medium in the hold-down region with a sealing member extending over at least a majority of a width of the print medium, so that the sealing member is sucked onto the print medium; and
driving the transport belt, thereby moving the print medium that is being held between the transport belt and the sealing member by the negative pressure.

12. The method according to claim 11, further comprising:
releasing the sealing member from the print medium; and
printing an image on the released print medium.
